(19) United States
(12) Patent Application Publication
(10) Pub. No.: US 2022/0283781 A1
(43) Pub. Date: Sep. 8, 2022

(54) QUANTUM RANDOM NUMBER GENERATION SYSTEM AND METHOD

(71) Applicant: NATIONAL UNIVERSITY OF SINGAPORE, Singapore (SG)

(72) Inventors: Ci Wen LIM, Singapore (SG); Chao WANG, Singapore (SG); Yukun WANG, Singapore (SG)

(21) Appl. No.: 17/625,080

(22) PCT Filed: Jul. 3, 2020
(86) PCT No.: PCT/SG2020/050382

§ 371 Date: Jan. 5, 2022

(30) Foreign Application Priority Data
Jul. 5, 2019 (SG) 10201906290U

(51) Int. Cl. G06F 7/58; G06N 10/40

(52) U.S. Cl. CPC G06F 7/588; G06N 10/40

(57) ABSTRACT

A quantum random number generation (QRNG) system includes a single-photon or equivalent single-photon light source; a beam splitter arranged to direct output from the light source to a first homodyne detector having a first local oscillator and a second homodyne detector having a second local oscillator; and a signal control and processing unit. The signal control and processing unit is configured to: vary the phases of the first and second local oscillators; receive, from the first and second homodyne detectors, a plurality of measurements of the output, said plurality of measurements being dependent on the intensity of the light source and the phases of the first and second local oscillators; determine, from the plurality of measurements, whether the CHSH inequality is satisfied; and output one or more random numbers based on whether the CHSH inequality is satisfied.

### TECHNICAL FIELD

The present invention relates, in general terms, to a quantum random number generation (QRNG) system and method.

### BACKGROUND

The generation of random numbers is an important activity in many applications, such as cryptography (encryption, authentication, digital signatures), finance (trading algorithms, e-currency), gambling, numerical simulations of physical processes, optimization problems that use Monte Carlo techniques, and fundamental research. The randomness and unpredictability of random numbers is key to information security, especially in cryptographic applications.

Random number generators (RNGs) can be classified into two broad categories: pseudo random number generators (PRNGs), which generate random numbers according to a deterministic algorithm that uses a seed value, and true random number generators (TRNGs), in which random numbers are generated in accordance with unpredictable physical effects, such as turbulences in a flow, or jitter in electrical circuits or circuit components.

A problem with most TRNGs that are based on physical phenomena is that they generate random numbers according to classical physics. Thus, although there is a degree of unpredictability that can be introduced by system noise or chaotic phenomena, the source of random numbers is ultimately deterministic.

As a result, more recently there have been attempts to devise quantum random number generators (QRNGs), based on quantum physical processes. Because quantum phenomena are inherently random, QRNGs provide a way to achieve true random number generation. However, the performance of QRNGs depends on which quantum property is exploited, the proper functioning of system components, and the ability to distinguish between randomness from genuine quantum process or predictable classical signal.

For example, in one known QRNG product developed by ID Quantique, single photons are injected on a semi-transparent mirror. Depending on which path the photon is detected (reflected or transmitted), the system announces bit 0 or bit 1 as the random output.

The operating principle of the ID Quantique system assumes that single photon generation is fully characterized, that the mirror is an ideal semi-transparent mirror, and that photon detection is perfect. However, if there are some device flaws (as is practically inevitable), or the core components deteriorate over time, the system may not actually implement an ideal quantum process. In other words, it will be difficult to determine if randomness is due to noise or quantum effects.

One solution to this problem is to fully characterize the properties of each component, and to modify the random number generation scheme accordingly. However, this causes another difficulty, namely that it still needs to be verified that the fully characterized system actually produces quantum random numbers in practice. There is presently no clear guidance as to how, or how often, accurate characterization of core quantum components should be performed.

It would be desirable to overcome or alleviate at least one of the above-described problems, or at least to provide a useful alternative.

### SUMMARY

Disclosed herein is a quantum random number generation (QRNG) system, including:
a single-photon or equivalent single-photon light source;
a beam splitter arranged to direct output from the light source to a first homodyne detector having a first local oscillator and a second homodyne detector having a second local oscillator; and
a signal control and processing unit configured to:
vary the phases of the first and second local oscillators;
receive, from the first and second homodyne detectors, a plurality of measurements of the output, said plurality of measurements being dependent on the intensity of the light source and the phases of the first and second local oscillators;
determine, from the plurality of measurements, whether the CHSH inequality is satisfied; and
output one or more random numbers based on whether the CHSH inequality is satisfied.

Also disclosed is a quantum random number generation (QRNG) method, including:
directing, by a beam splitter, output from a single-photon or equivalent single-photon light source to a first homodyne detector coupled to a first local oscillator and a second homodyne detector coupled to a second local oscillator;
varying the phases of the first and second local oscillators;
receiving at a signal control and processing unit, from the first and second homodyne detectors, a plurality of measurements of the output, said plurality of measurements being dependent on the intensity of the light source and the phases of the first and second local oscillators;
determining, from the plurality of measurements, whether the CHSH inequality is satisfied; and
outputting one or more random numbers based on whether the CHSH inequality is satisfied.

Also disclosed is a photonic chip including a system as disclosed herein and/or implementing a method as disclosed herein.

### BRIEF DESCRIPTION OF THE DRAWINGS

Embodiments of the present invention will now be described, by way of non-limiting example only, with reference to the accompanying drawings in which:

FIGS. 1(a) and 1(b) show high-level schematic depictions of a quantum random number generator (QRNG) according to certain embodiments;

FIG. 2 is a block diagram of an example architecture of a signal control and processing module of a QRNG;

FIG. 3 is a schematic diagram of another possible realization of a QRNG according to certain embodiments;

FIG. 4 is a schematic diagram of an example implementation of a QRNG as a photonic chip;

FIG. 5 is a graph of the number of random bits as a function of detector threshold, produced by a QRNG according to certain embodiments;

FIG. 6 is a graph of CHSH violation as a function of detector threshold for a QRNG according to certain embodiments; and

FIG. 7 is another graph of the number of random bits as a function of detector threshold, produced by a QRNG according to certain embodiments.

### DETAILED DESCRIPTION

Embodiments of the present invention provide a method and system for generating certifiable quantum random numbers based on quantum nonlocal correlations and homodyne detection.

Embodiments of the invention are able to guarantee that the output randomness comes from genuine quantum correlations, without using any costly equipment such as single photon detectors.

Embodiments provide a method and system for self-testing QRNG, the randomness of which depends solely on the violation of a Bell's inequality, indicating the genuine random property of quantum entanglement instead of the proper functioning of devices. Accordingly, there can be certainty that the randomness comes from a quantum process, and not from classical noise caused by component deterioration.

In previous QRNG based on Bell's inequality violation, stringent experimental requirements are required, such as high-quality entanglement generation and single photon detection. In contrast, embodiments of the QRNG method disclosed herein can be performed with only off-the-shelf components, such that the cost is greatly reduced compared to previously known approaches.

In general, the method and system according to the present embodiments inject single photons onto a 50:50 beam splitter in a sequence, and thereafter generate a series of entangled quantum states in terms of two different output paths a and b:

$${{{{\vert {Ψ}^{-} 〉 = \frac{1}{\sqrt{2}} ( \vert 0 〉}_{a} \vert 1 〉}_{b} - \vert 1 〉}_{a} \vert 0 〉}_{b} )$$

The correlations of these quantum entangled states, which can be quantified by CHSH inequality violations, are utilized to ensure that the randomness is of quantum and not classical nature.

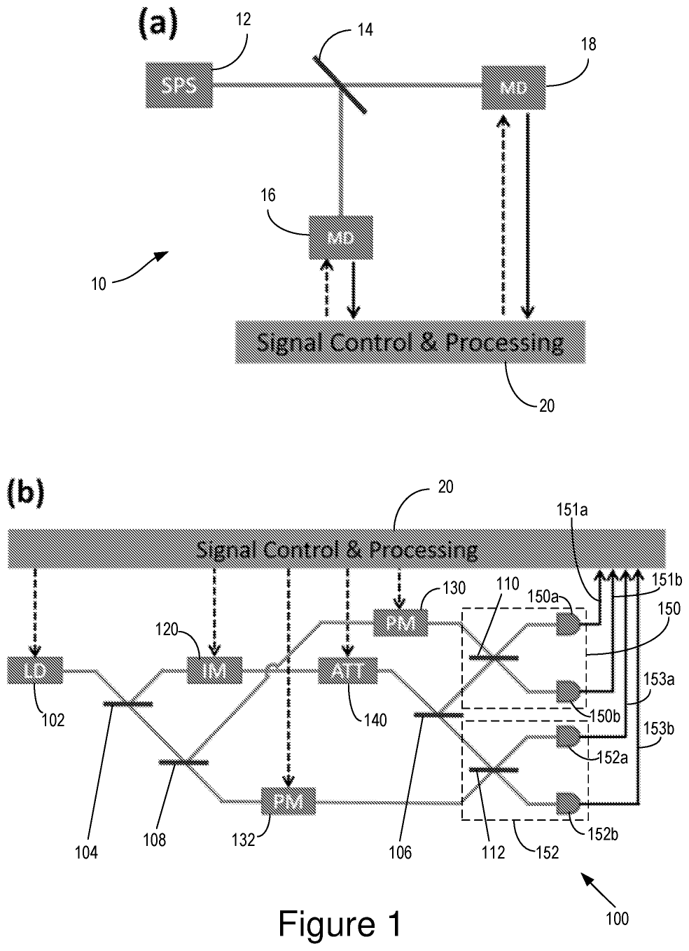

Referring initially to FIG. 1(a), an embodiment of a quantum random number generation (QRNG) system 10 includes a single-photon or equivalent single-photon light source 12 configured to output light at single-photon level. The output of source 12 is directed towards a 50:50 beam splitter 14 to generate a train of single-photon entangled states, each of which is detected by either a first measurement device 16 or a second measurement device 18.

The system 10 may broadly be considered to implement three functions: quantum state generation, quantum state measurement, and signal modulation and acquisition.

Quantum state generation may be implemented by the single photon source 12 (which may, for example, include a laser diode, intensity modulator, and attenuator), and the 50:50 beam splitter 14. In the ideal case, a single photon source may be used to generate entanglement. However, it is possible to provide an equivalent single photon source by other means, for example by using coherent states and the decoy state technique to retrieve the single photon contribution. To perform this technique, the intensity of the coherent states is varied, and appropriate post-processing is performed, as will be described in further detail below. A laser diode may be used to generate the coherent states, an intensity modulator may be used for intensity variation, and an attenuator may be used for single photon level power attenuation.

The quantum state measurement part is depicted as first measurement device 16 and second measurement device 18 in FIG. 1(a), which may include two sets of homodyne detectors and associated local oscillators, the phases of which can be controlled by phase modulators. Each homodyne detector may include one pair of photodetectors and electrical amplifiers. By changing the phase of the two local oscillators, measurement statistics conditioned on different settings can be obtained to estimate the degree of Bell violation as well as the minimum randomness that can be obtained from the system.

The first measurement device 16 may comprise a first balanced homodyne detector that is coupled to a first local oscillator; likewise, the second measurement device 18 may comprise a second balanced homodyne detector that is coupled to a second local oscillator. The use of balanced homodyne detectors is advantageous as it means that cooling is not required, thus making the system according to embodiments suitable for integration into photonic chips that operate at room temperature.

The signal modulation and acquisition part, which is represented by the signal control and processing module 20 in FIG. 1(a), is responsible for modulation of control signals for components such as the intensity modulator and attenuator of the quantum state generation part and the phase modulators of the quantum state measurement part, real-time calibration of the system, and data processing to generate the final random numbers.

Signal control and processing unit 20 performs a number of functions, including controlling the phases of the first and second local oscillators of the homodyne detectors 16 and 18, controlling the intensity of the source 12, acquiring signals from photodetectors of homodyne detectors 16 and 18, and performing various processing operations on the acquired signals to facilitate the generation of random numbers. The processing may include, for example, analyzing a sequence of measurements (conditioned on the phases of the local oscillators and the intensity of the source 12) to determine whether the CHSH inequality is satisfied, and thus whether randomness observed in the sequence is due to quantum or classical sources. Randomness extraction may then be performed responsive to detection of violation of the CHSH inequality.

The present invention is predicated on the realization that entanglement of single photons can be used to create random numbers via homodyning measurements on the vacuum and single-photon subspaces. Crucially, in doing so, it is possible to self-test the quality of the quantum process and determine the amount of private randomness that can be extracted from the measurement data. If any system components are faulty, this will be reflected in a reduced degree of Bell violation, and thus a reduction in randomness extraction.

Advantageously, embodiments of the invention make use of ultra-fast homodyne detection and laser sources, thus providing the ability to generate up to and beyond 1GHz of random numbers. In simulations conducted by the present inventors based on off-the-shelf components, it has been found that the method can readily generate up to 1.4 Gbit per second of quantum certified random numbers.

One possible realization of a QRNG system is shown in schematic form in FIG. 1(b), in which solid lines represent optical paths, solid lines with arrows represent output signals, and dotted lines with arrows represent control signals.

The QRNG system 100 implements quantum state generation using a laser diode 102 that irradiates a first beam splitter 104. The first beam splitter is arranged to direct a first beam towards an intensity modulator 120, the output of which is directed towards an attenuator 140 that is arranged to attenuate the power of the first beam to single-photon level. The output of the attenuator 140 is directed towards a second beam splitter 106 to generate an entangled state.

The QRNG system 100 implements quantum state measurement using a first balanced homodyne detector 150 and a second balanced homodyne detector 152. A third beam splitter 108 is arranged to receive a second beam from the first beam splitter 104, and to further split the second beam along first and second optical paths towards respective phase modulators 130 and 132. The first phase modulator 130 feeds into the first balanced homodyne detector 150, to provide a first local oscillator signal for the first balanced homodyne detector 150. Likewise, the second phase modulator 132 feeds into the second balanced homodyne detector 152, to provide a second local oscillator signal for the second balanced homodyne detector 152. First balanced homodyne detector 150 includes a beam splitter 110 arranged to direct input photons from the quantum state generation part and the phase modulator 130 into photodetectors 150a and 150b. Second balanced homodyne detector 152 includes a beam splitter 112 arranged to direct input photons from the quantum state generation part and the phase modulator 132 into photodetectors 152a and 152b.

The QRNG system 100 further includes a signal control and processing (SCP) module 20. SCP module 20 transmits control signals to laser diode 102, intensity modulator 120, attenuator 140, and phase modulators 130, 132 to change the intensity of the coherent states from laser diode 102, and the phases of the local oscillator signals for homodyne detectors 150, 152. SCP module 20 also receives photocurrent measurements from the homodyne detectors 150, 152 which form the basis of random number generation. Photocurrent from the photodetectors 150a, 150b travels along signal lines 151a, 151b to SCP module 20, and photocurrent from 152a, 152b travels along signal lines 153a, 153b.

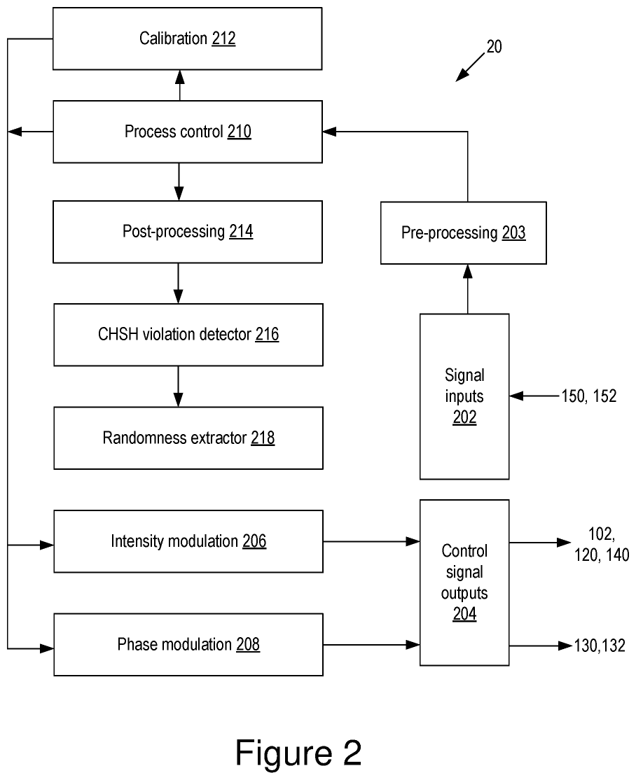

An example architecture of an SCP module 20 is shown in FIG. 2. Part or all of the SCP module 20 may be a self-contained component, such as a system-on-a-chip (SOC), but it will be appreciated that different sub-modules of SCP module 20 may form part of separate physical components.

SCP module 20 may include a signal input component 202 to receive photocurrent signals from homodyne detectors 150 and 152, and may also receive signals from other parts of the QRNG, for example for diagnostic purposes. SCP module 20 also includes a control signal output module 204 that enables the SCP 20 to transmit control signals to components such as the laser diode 102, intensity modulator 120, and attenuator 140, to switch them on or off or to tune them to achieve a desired output intensity. Control signal output 204 also transmits signals to phase modulators 130 and 132 to control their operation, for example to switch between two predetermined phase values of the local oscillators of the homodyne detectors.

The photocurrent signals received at signal input 202 may be preprocessed using methods known in the art, by a preprocessing module 203, and the preprocessed signals may be transmitted to other components of the SCP 20 for further processing.

SCP 20 also includes a process control module 210 that coordinates the overall operation of the SCP 20, and thus of the QRNG 100.

For example, process control module 210 may be configured to conduct a calibration process, via calibration module 212. Calibration module 212 may be configured to turn on laser diode 102, calibrate the intensity of the coherent states using the intensity modulator 120 and attenuator 140, and calibrate the phase references of the local oscillators with phase modulators 130 and 132, by monitoring the homodyne detector 150, 152 output signals received at signal input 102.

Process control module 210 may also be configured to carry out a random number generation process by modulating the intensity and phase of coherent states produced by laser diode 102, determining a plurality of photocurrent measurements at the different intensities and phases, and then passing the plurality of photocurrent measurements to one or more data processing modules that extract random numbers based on the photocurrent measurements.

For example, in each measurement round, process control module 210 may determine the specific intensity of the coherent state μ∈{μ₁, μ₂, . . . μ_{M}} and the phase choices of the local oscillators θⱼⁱ, where i∈{a, b} represents one of the two balanced homodyne detectors 150 and 152, and j∈{0,1} indicates two different phase settings of the local oscillator. The intensity and phase choices are then propagated, via intensity modulation component 206 and phase modulation component 208, to intensity modulator 120, attenuator 140, and phase modulators 130, 132, via the control signal output 204.

Process control module 210 may then receive a plurality of photocurrent measurements performed by the balanced homodyne detectors 150, 152. The raw photocurrent measurements may be provided to post-processing module 214, which determines a measurement outcome M_{i,j}^{μ} from each balanced homodyne detector 150 or 152.

Each measurement outcome represents a photocurrent difference between the photodetectors of the homodyne detector (e.g., the difference between photocurrents measured by photodetectors 150a and 150b of homodyne detector 150). The measurement outcome is conditioned on intensity of the quantum state p and the phase settings of local oscillator j∈{0,1}. That is, each measurement is associated with a particular quantum state intensity and local oscillator phase setting.

Post-processing module 214 may compare the measurement results M_{i,j}^{μ} with a set of predefined post-selecting thresholds {−t, t}. As will be understood by those skilled in the art, the thresholds may be selected in order to optimize the random number generation rate. If M_{i,j}^{μ}>t, the final measurement result of the specific balanced homodyne detector [symbol] 0 is assigned to be 1, and if M_{i,j}^{μ}<−t, [symbol] s assigned to be −1.

Next, by conditioning on different settings of θⱼⁱ and related measurement outcome [symbol] , post-processing module 214 can obtain the normalized correlation probability (for each coherent state μ), [symbol] Further, by deploying the decoy state technique, the post-processing module 214 can obtain the single photon contribution of the correlation measurement, P_{ja,jb,}¹ [symbol] .

The decoy state technique can be used to obtain the statistics of single photon events in the following way.

In the system according to the presently disclosed embodiments, phase-randomized weak coherent states (WCS) having three or more different intensities are used to reconstruct the single photon statistics with high precision.

By randomizing the phase of the coherent states, the density matrix of the coherent state can be rewritten as the mixture of density matrices of a series of photon number states (Fock states), which follows the Poisson distribution. Then the success probability (i.e., the probability that a coherent state generates measurements that fulfil the CHSH inequality) of the three WCS {μ₁, μ₂, μ₃} can be represented as:

Q_{μ}_{₁}=P_{μ}_{₁}⁰Y⁰+P_{μ}_{₁}¹Y¹+P_{μ}_{₁}²Y⁰+. . .

Q_{μ}_{₂}=P_{μ}_{₂}⁰Y⁰+P_{μ}_{₂}¹Y¹+P_{μ}_{₂}²Y²+. . .

Q_{μ}_{₃}=P_{μ}_{₃}⁰Y⁰+P_{μ}_{₃}¹Y¹+P_{μ}_{₃}²Y²+. . .

In the above, Q_{μ}_{₁} indicates the probability that the system obtains successful events (i.e., events that satisfy the CHSH inequality) when phase-randomized coherent state μ₁ is used, P_{μ}_{₁}⁰ indicates the probability of zero photons occurring in the WCS with intensity μ₁, and Y⁰ means the probability that the system obtains successful events when the zero-photon Fock state |0 [symbol] has been used, and likewise for the other quantities above. Because the coherent states are weak coherent states, the probabilities of more than 2 photons are very small, and can be neglected to a good approximation such that the above sums can be truncated at 2-photon order.

Accordingly, by solving the three linear equations above, it is possible to obtain P¹, which is the single photon contribution.

In some embodiments, more than three coherent states may be used in the decoy state technique. This will result in higher precision in the estimate of P¹. It will be understood that the sums above may then be extended to higher order, such that, for example, if four weak coherent states are used, the 3-photon contribution can be included such that there are four equations in four unknowns.

In some previous implementations of the decoy state technique, one or more vacuum states are used as the decoy states. In at least some of the presently disclosed embodiments, all states are weak coherent states.

The single photon correlation probabilities may be provided to a CHSH violation detector 216. Based on the normalized correlation probability, CHSH violation detector 216 can evaluate the Bell violation observed in the system using an inequality called the CHSH inequality:

S=E(θ₀^{a},θ₀^{b})+E(θ₀^{a},θ₁^{b})+E(θ₁^{a},θ₀^{b})−E(θ₁^{a},θ₁^{b}),

where E(θⱼₐ^{a},θ_{jb}^{b})=(P_{ja,jb,-1,-1}¹−P_{ja,jb,-1,1}¹−P_{ja,jb,1,-1}¹+P_{ja,jb,1,1}¹)/P_{ja,jb-1,-1}¹+P_{ja,jb,-1,1}¹+P_{ja,jb,1,-1,}¹+P_{ja,jb,1,1}¹). As is known to those skilled in the art, any strategy based on a local deterministic event will lead to S≤2, while for entangled quantum systems, the outcome of two measurement settings may result in S>2, meaning that not all the observed outputs can be predetermined and that at least some of the results arise from intrinsic quantum correlations. Accordingly, if CHSH violation detector 216 determines that S>2, the current round of measurements may be used to generate quantum random numbers by randomness extraction or privacy amplification.

In cases where S>2, the CHSH violation detector 216 passes the [symbol] to a randomness extractor 218. The amount of randomness (R) of the system 100 (the average number of extractable random numbers in each experimental trial) can be linked to CHSH statistics through the Von Neumann entropy:

$$R \geq 1 - {h}_{2} ( \frac{1}{2} + \frac{1}{2} \sqrt{\frac{{S}^{2}}{4} - 1} )$$

Randomness extractor 218 may take into account realistic system imperfections like statistical fluctuations of measurement results, possible correlations among a series of measurements, and deploy a more rigorous formula to estimate the final amount of random numbers in a given total number of trials.

Thereafter, a randomness extractor can be constructed accordingly, to distill the final random numbers. For example, a hashing function, such as a universal hashing function, may be used for randomness extraction (see R. Renner and R. Konig, Universally Composable Privacy Amplification Against Quantum Adversaries. In Theory of Cryptography, 407-425 (Springer, 2005), the contents of which are hereby incorporated by reference). In one example, a

Toeplitz-hashing extractor may be used. In another example, Trevisan's extractor may be used (see X. Ma et al., Phys. Rev. A 87, 062327, the contents of which are hereby incorporated by reference). Many other randomness extraction or privacy amplifications that are suitable for use in quantum random number generated may be used, as will be appreciated by those skilled in the art.

A seed value for the randomness extractor may be obtained by, for example, using random numbers generated from previous rounds of measurement and random number extraction. Since a universal hashing function does not need to be changed during every round, use of some of the previously generated random numbers should not excessively consume the generated random numbers.

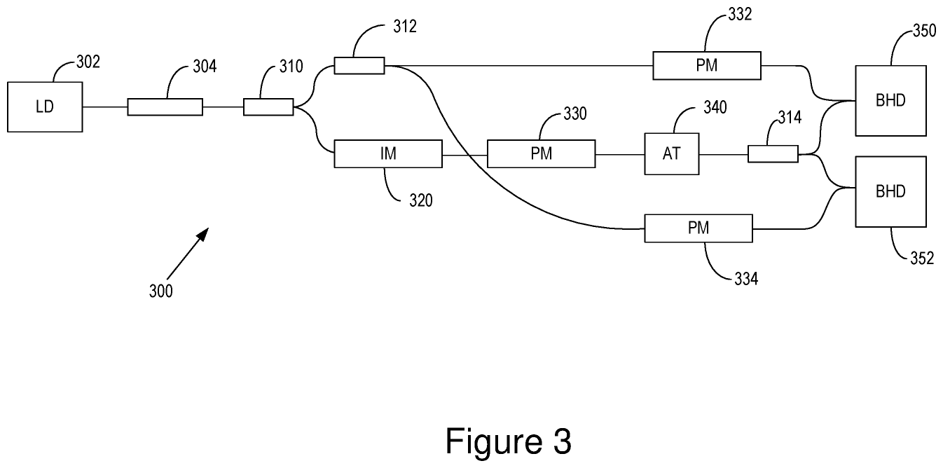

Referring now to FIG. 3, a further example of a QRNG 300 is shown. QRNG 300 implements quantum state generation using a laser diode 302 that irradiates a polarizing beam splitter 310. A polarization controller 304 may be interposed in the beam path between the laser diode 302 and first beam splitter 310 to control the intensity distribution between the signal and local oscillators of two balanced homodyne detectors 350, 352. The polarizing beam splitter is arranged to direct a first beam towards an intensity modulator 320, the output of which is directed, via a polarization modulator 330, towards an attenuator 340 that is arranged to attenuate the power of the first beam to single-photon level. The polarization modulator 330 may be used to randomize the phase of the signal for implementation of the decoy state mechanism. In some embodiments, the polarization modulator 330 may not be required for this purpose; for example, a gain-switched laser diode 302 may be used to generate a pulse of coherent states, thereby providing intrinsically random phases for the decoy state mechanism to be deployed. The output of the attenuator 340 is directed towards a beam splitter 314 to generate an entangled state.

The QRNG system 300 implements quantum state measurement using a first balanced homodyne detector 350 and a second balanced homodyne detector 352. A third beam splitter 312 is arranged to receive a second beam from the first (polarizing) beam splitter 310, and to further split the second beam along first and second optical paths towards respective phase modulators 332 and 334. The first phase modulator 332 feeds into the first balanced homodyne detector 350, to provide a first local oscillator signal for the first balanced homodyne detector 350. Likewise, the second phase modulator 332 feeds into the second balanced homodyne detector 352, to provide a second local oscillator signal for the second balanced homodyne detector 352. First and second balanced homodyne detectors 350, 352 may be structured in similar fashion to the first and second homodyne detectors 150, 152 of FIG. 1(b).

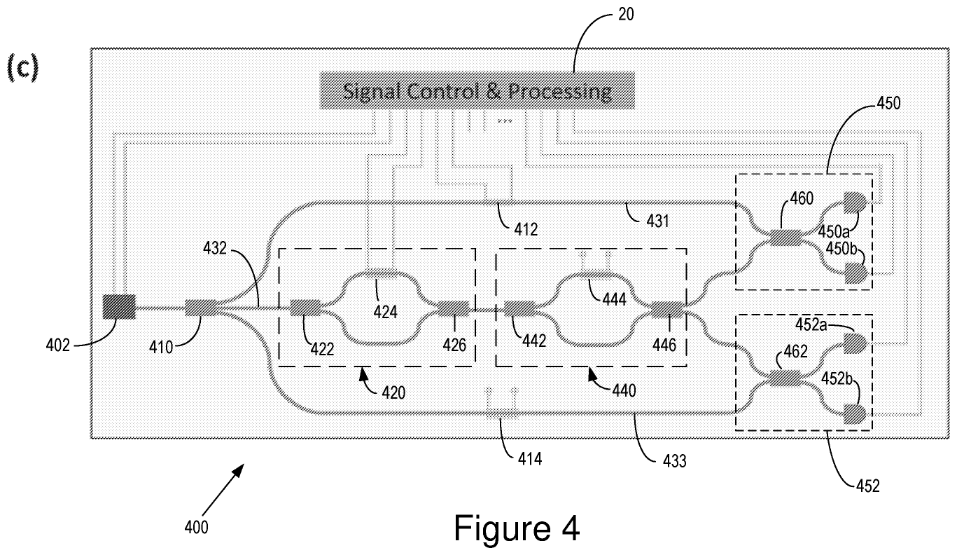

The components of the QRNG system 300 are each coupled to a signal control and processing (SCP) module, such as the SCP module 20, though these connections are not shown in FIG. 4.

Advantageously, the QRNG systems 100, 300 are able to generate quantum random numbers at greater speed than previously known systems, using standard optical components instead of costly and highly customized components such as single-photon detectors. The speed of the QRNG system 100, 300 can be boosted further, by deploying high speed balanced homodyne detectors (such as Finisar CPRV1222A light sensors) for quantum entanglement detection, instead of using conventional shot-noise-limited (SNL) BHDs. A high-speed BHD may have a nominal 3 dB bandwidth of 25 GHz, over 20 times faster than the state-of-the-art SNL BHD. To address the high electrical noise problem, three reasonable assumptions on the electrical noise can be made: 1) electrical noise from two detectors (e.g. 150, 152) should be independent from each other, 2) electrical noise is independent of the measured quantum signal and 3) it possesses a Gaussian distribution. As such, if these assumptions hold, the effect of electrical noise is equivalent to optical loss on the signal. Hence, the resultant output of the laser source together with the equivalent optical loss can be seen as the source of quantum states. Since the electrical noise of the detectors is independently localized, they will not contribute to the nonlocal correlations of the single photon entangled state. Therefore, the influence of the electrical noise can be easily removed, overcoming the strict trade-off between noise and bandwidth in electrical circuit designs that use SNL BHD.

In fact, other practical issues, like the noise of the data acquisition equipment (e.g. ADC), inefficiency of the photodiode, polarization mismatch between signal and local oscillators and the like, can also be addressed with this loss-equivalent scheme, leading towards the quantum maximal violation of the CHSH inequality.

In a lab-scale system, the output of the BHDs (e.g. 150, 152) may be acquired by a high speed oscilloscope (Tektronix DPO72004C) with a bandwidth of 20 GHz and a sample rate of 50 GS/s. The acquired data can then be stored for offline digital signal processing (DSP). As a consequence, the down-converted data with a sample rate of 40 GS/s possesses a minimum correlation among the trials according to the Wiener-Khinchin theorem. As will be appreciated, and as discussed above, some embodiments may implement a QRNG in integrated circuit form (such as in a photonic chip), in which case the data acquisition and DSP functions may be integrated in components within the chip itself.

In some embodiments, the final random output bits may be obtained through high speed randomness extraction on FPGA hardware. In order to account for finite data size effects, the Entropy Accumulating Theorem (EAT) may be used to obtain a random number generation rate in the security proof.

A possible realization of a QRNG as a photonic chip will now be described with reference to FIG. 4. The photonic chip 400 is analogous to the QRNG system 300 shown in FIG. 3.

It will be appreciated that the photonic chip 400 comprises a number of components and features that are typical for such devices, such as a substrate, and at least one light-guiding (photonic circuit) layer, and that the light-guiding structures may comprise optical fibers, optical waveguides and the like. These components and features will not be described in detail herein.

Photonic chip 400 implements quantum state generation using a laser diode 402 that irradiates a beam splitter 410. Unlike the arrangement of FIG. 3, with beam splitters 310 and 312, a single 3-output beam splitter can be used to guide light from the laser diode 402 into three different paths 431, 432 and 433. Paths 431 and 433 are used to generate a local oscillator signal for balanced homodyne detectors 450 and 452 respectively, by phase modulation implemented by respective phase modulators 412 (along path 431) and 414 (along path 433).

Light travels along path 432 to a first interferometer 420 that functions as an intensity modulator. Intensity modulator 420 comprises a first beam splitter 422 that splits the beam into first and second beams, the beams then recombining at a second beam splitter 426, with the first beam having traversed phase modulator 424 on the way. The phase modulator 424 is under the control of signal control and processing module 20.

The output of the intensity modulator 420 is directed towards a second interferometer 440 that functions as an attenuator. Attenuator 440 comprises a first beam splitter 442 that guides light into first and second paths which recombine at a second beam splitter 446. Light travelling along the first path traverses a phase modulator 444 which, again, is under the control of signal control and processing module 20, such that the attenuator 440 can be configured to attenuate the power of the beam emerging from the attenuator 440 to single-photon level. The phase modulator 444 may be used to randomize the phase of the signal for implementation of the decoy state mechanism, or the laser diode 402 may be a gain-switched laser diode that is used to generate a pulse of coherent states, thereby providing intrinsically random phases for the decoy state mechanism to be deployed.

The output of the attenuator 440 is an entangled state that is generated by the beam splitter 446 once the signal has been attenuated to single-photon level. The output entangled state is then measured using the first balanced homodyne detector 450 and second balanced homodyne detector 452. First balanced homodyne detector 450 includes a beam splitter 460 arranged to direct input photons from the attenuator 440 and the phase modulator 412 into photodetectors 450a and 450b. Second balanced homodyne detector 452 includes a beam splitter 462 arranged to direct input photons from the attenuator 440 and the phase modulator 414 into photodetectors 452a and 452b.

As mentioned above, the first phase modulator 412 feeds into the first balanced homodyne detector 450, to provide a first local oscillator signal along path 431 for the first balanced homodyne detector 450. Likewise, the second phase modulator 414 feeds into the second balanced homodyne detector 452, to provide a second local oscillator signal along path 433 for the second balanced homodyne detector 452.

### Experimental Results

To simulate the practical performance of the QRNG system 100, a realistic model was developed, in accordance with the teachings of J. Appel, D. Hoffman, E. Figueroa, and A. I. Lvovsky, Phys. Rev. A 75, 035802 (2007), the entire contents of which are hereby incorporated by reference, to take into account realistic system imperfections like electrical noise of homodyne detectors 150 and 152, statistical fluctuation of measurements, etc.

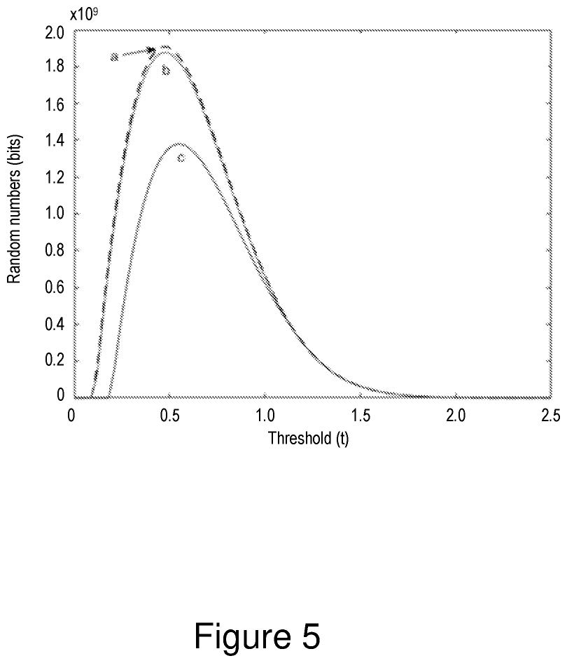

The total number of trials (with each trial corresponding to one measurement result from each homodyne detector) for the simulation was set to be 10¹⁰. The simulation demonstrated that intrinsic random numbers can be obtained from the system φas a function of the post-selecting threshold {−t, t}, which is illustrated in FIG. 5.

FIG. 5 shows the total amount of random numbers versus the post-selecting threshold t. δ, ∈ₛ, and ∈ₑ are error parameters for the calculation. Curve a is the ideal result without considering electrical noise or statistical fluctuations. Curve b corresponds to the results when considering statistical fluctuations and security analysis but without noise. Curve c is the amount of random numbers that can be obtained in practical systems, under the consideration of system noise, statistical fluctuations, etc.

From curve c of FIG. 5, which considers practical system imperfections, it can be seen that if the working frequency of the system 100 is set to be 1 GHz, a rough random number generation rate of around 140 Mbits/sec can be obtained. This is much higher than existing commercial QRNG products from ID Quantique, which gives a generation rate of 4 Mbits/sec for a single device.

A system in accordance with QRNG 300 was constructed and used to perform quantum random number generation. Using optimized parameters from theoretical analysis of the system 300 (i.e., by modelling the system 300 and determining parameters which maximize the amount of extractable randomness), a CHSH violation of 2.38 was achieved, which can lead to a high throughput random number generation of larger than 1 Gbps.

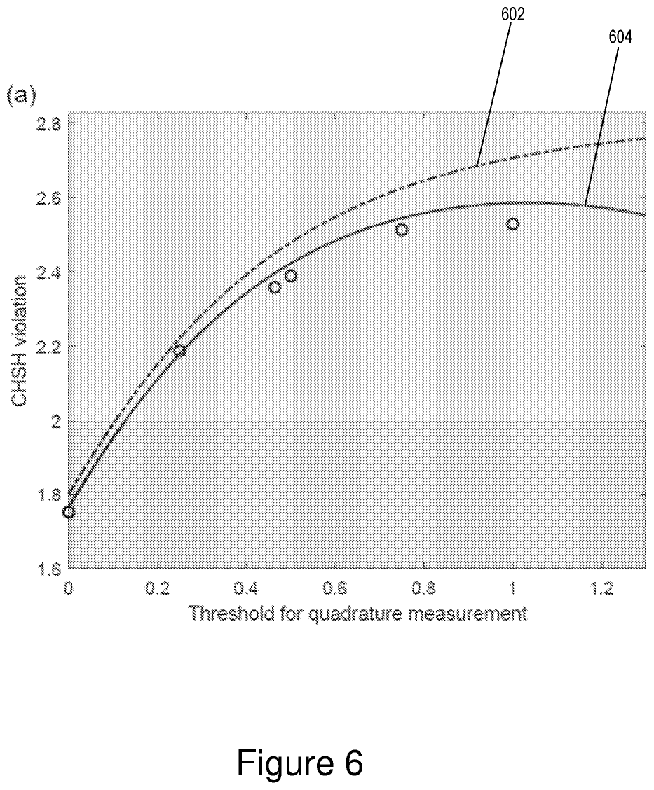

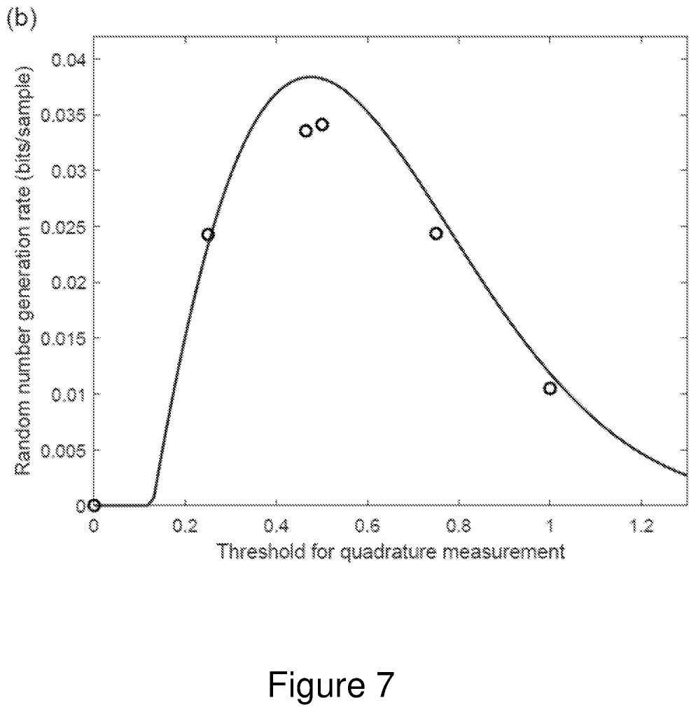

FIGS. 6 and 7 show experimental results from the QRNG 300. FIG. 6 shows CHSH violation versus threshold settings. The dash-dotted line 602 shows the theoretical CHSH violation (as reflected by S, as discussed above) with an ideal single photon source. The solid line 604 shows the theoretical CHSH violation when a three-intensity decoy state method is used. The circles indicate experimental results achieved by system 300.

FIG. 7 shows the final random number generation rate versus the threshold. The solid line indicates the theoretical (simulated) random number generation rate when a three-intensity decoy state method is used, while the circles indicate the experimental results.

As can be seen from the foregoing, embodiments of the present invention provide a simple and economical way to generate randomness from an intrinsic entangled quantum system, which is not influenced by the functioning of constitutive components like beam splitters, detectors, and the like. Instead, modulation of phases and intensities is used to generate measurements from which the randomness can be extracted. This is much easier to control than the condition of electrical or optical system components. In addition, embodiments can be implemented using standard components, thus facilitating implementation in photonic chips. Furthermore, according to simulation results, the estimated amount of random numbers of the presently proposed system can be much higher than that of known QRNG products.

Many modifications will be apparent to those skilled in the art without departing from the scope of the present invention.

Throughout this specification, unless the context requires otherwise, the word “comprise”, and variations such as “comprises” and “comprising”, will be understood to imply the inclusion of a stated integer or step or group of integers or steps but not the exclusion of any other integer or step or group of integers or steps.

The reference in this specification to any prior publication (or information derived from it), or to any matter which is known, is not, and should not be taken as an acknowledgment or admission or any form of suggestion that that prior publication (or information derived from it) or known matter forms part of the common general knowledge in the field of endeavor to which this specification relates.

1. A quantum random number generation (QRNG) system, including comprising:
a single-photon or equivalent single-photon light source;
a beam splitter arranged to direct output from the light source to a first homodyne detector having a first local oscillator and a second homodyne detector having a second local oscillator; and
a signal control and processing unit configured to:
vary the phases of the first and second local oscillators;
receive, from the first and second homodyne detectors, a plurality of measurements of the output, said plurality of measurements being dependent on the intensity of the light source and the phases of the first and second local oscillators;
determine, from the plurality of measurements, whether the CHSH inequality is satisfied; and
output one or more random numbers based on whether the CHSH inequality is satisfied.

2. The QRNG system according to claim 1, wherein the light source is configured to generate a plurality of coherent states of varying intensity, and wherein the system includes an attenuator for attenuating the output to single-photon level.

3. The QRNG system according to claim 1 or claim 2, wherein the signal control and processing unit is configured to determine a set of single photon correlation probabilities from said plurality of measurements; and
determine, based on the set of single photon correlation probabilities, whether the CHSH inequality is satisfied.

4. The QRNG system according to claim 1, wherein the signal control and processing unit is configured to apply a threshold to respective measurements prior to determining whether the CHSH inequality is satisfied.

5. The QRNG system according to claim 1, wherein the signal control and processing unit is configured to apply a randomness extractor to the one or more random numbers.

6. The QRNG system according to claim 5, wherein the randomness extractor is a universal hashing function.

7. A quantum random number generation (QRNG) method, including the method comprising:
directing, by a beam splitter, output from a single-photon or equivalent single-photon light source to a first homodyne detector coupled to a first local oscillator and a second homodyne detector coupled to a second local oscillator;
varying the phases of the first and second local oscillators;
receiving at a signal control and processing unit, from the first and second homodyne detectors, a plurality of measurements of the output, said plurality of measurements being dependent on the intensity of the light source and the phases of the first and second local oscillators;
determining, from the plurality of measurements, whether the CHSH inequality is satisfied; and
outputting one or more random numbers based on whether the CHSH inequality is satisfied.

8. The QRNG method according to claim 7, wherein the light source is configured to generate a plurality of coherent states of varying intensity; and wherein the method includes attenuating the output to single-photon level.

9. The QRNG method according to claim 7, further comprising including determining a set of single photon correlation probabilities from said plurality of measurements; and
determining, based on the set of single photon correlation probabilities, whether the CHSH inequality is satisfied.

10. The QRNG method according to claim 7, further comprising applying a threshold to respective measurements prior to determining whether the CHSH inequality is satisfied.

11. The QRNG method according to claim 7, further comprising applying a randomness extractor to the one or more random numbers.

12. The QRNG method according to claim 11, wherein the randomness extractor is a universal hashing function.

13. (canceled)

14. A system comprising:
an integrated circuit; and
memory encoding computer executable instructions that, when executed by the integrated chip, perform a method comprising:
directing, by a beam splitter, output from a single-photon or equivalent single-photon light source to a first homodyne detector coupled to a first local oscillator and a second homodyne detector coupled to a second local oscillator;
varying the phases of the first and second local oscillators;
receiving at a signal control and processing unit, from the first and second homodyne detectors, a plurality of measurements of the output, said plurality of measurements being dependent on the intensity of the light source and the phases of the first and second local oscillators;
determining, from the plurality of measurements, whether the CHSH inequality is satisfied; and
outputting one or more random numbers based on whether the CHSH inequality is satisfied.

15. The system method according to claim 14, wherein the light source is configured to generate a plurality of coherent states of varying intensity; and wherein the method includes attenuating the output to single-photon level.

16. The system according to claim 14, wherein the method further comprises:
determining a set of single photon correlation probabilities from said plurality of measurements; and
determining, based on the set of single photon correlation probabilities, whether the CHSH inequality is satisfied.

17. The system according to claim 14, wherein the method further comprises applying a threshold to respective measurements prior to determining whether the CHSH inequality is satisfied.

18. The system according to claim 14, wherein the method further comprises applying a randomness extractor to the one or more random numbers.

19. The system according to claim 18, wherein the randomness extractor is a universal hashing function.

20. The system according to claim 14, wherein the integrated circuit is a photonic chip.
